(19) United States
(12) Patent Application Publication
(10) Pub. No.: US 2015/0221434 A1
(43) Pub. Date: Aug. 6, 2015

(54) METHOD OF MANUFACTURING AN INDUCTIVE MODULE

(71) Applicant: TAIMAG CORPORATION, N.E.P.Z. Kaohsiung (TW)

(72) Inventor: Pin-Hung Chen, N.E.P.Z. Kaohsiung (TW)

(73) Assignee: TAIMAG CORPORATION, N.E.P.Z. Kaohsiung (TW)

(21) Appl. No.: 14/172,855

(22) Filed: Feb. 4, 2014

(51) Int. Cl. H01F 41/04

(52) U.S. Cl. CPC H01F 41/046

(57) ABSTRACT

A method of manufacturing an inductive module includes: (a) injection molding a plastic material to form a substrate that has opposite first and second surfaces and at least one receiving space indented from the first surface to the second surface; (b) disposing a ferromagnetic core unit in the receiving space; (c) forming conductive traces on the first and second surfaces of the substrate and forming conductive vias through the substrate, each of the conductive traces being electrically connected to a corresponding pair of the conductive vias; and (d) covering the conductive traces with a solder mask such that a part of the conductive traces are exposed to serve as contacts, followed by subjecting to a contact finishing process.

### BACKGROUND OF THE INVENTION

1. Field of the Invention

This invention relates to a method of manufacturing an inductive module.

2. Description of the Related Art

A conventional inductive device, such as an inductor, a transformer, etc., is composed of one or more windings wound around a ferromagnetic core that is made from a ferromagnetic material. Electromagnetic effects occur between the winding and the ferromagnetic core when electric current flows through the winding. For producing smaller transformers, processes of winding the windings, usually in the form of enamel-covered wires, around the ferromagnetic core still rely on manual labor. However, such manual operations have shortcomings of being time-consuming and a low production rate.

In order to solve the above shortcomings, the ferromagnetic core is embedded in a printed circuit board (PCB), and vias are formed in the PCB by drilling and electroplating as a winding.

Generally, a printed circuit board is made by laminating multiple layers of FR-4 resin material. There are two common ways to embed the ferromagnetic core in the printed circuit board: (1) disposing the ferromagnetic core between the layers of the resin material followed by hot pressing; and (2) directly forming a blind hole in the printed circuit board, followed by disposing the ferromagnetic core in the blind hole.

However, the structure of the ferromagnetic core might be damaged in the hot pressing process, and the ferromagnetic core might become ineffective due to the high temperature of the hot pressing process. Furthermore, formation of the blind hole should be precisely controlled since the printed circuit board is relatively thin and is likely to be damaged. Thus, manufacturing costs become high and the yield is unlikely to be improved.

### SUMMARY OF THE INVENTION

Therefore, the object of the present invention is to provide a method of manufacturing an inductive module that can overcome at least one of the aforesaid drawbacks of the prior art.

According to this invention, a method of manufacturing an inductive module comprises the following steps:

(a) injection molding a plastic material to form a substrate that has opposite first and second surfaces and at least one receiving space indented from the first surface to the second surface;

(b) disposing a ferromagnetic core unit in the receiving space;

(c) forming conductive traces on the first and second surfaces of the substrate and forming conductive vias through the substrate, each of the conductive traces being electrically connected to a corresponding pair of the conductive vias; and

(d) covering the conductive traces with a solder mask such that a part of conductive traces are exposed to serve as contacts, followed by subjecting to a contact finishing process.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a flowchart of the preferred embodiment of a method of manufacturing an inductive module according to this invention;

FIG. 2 is a top view illustrating a substrate with receiving spaces formed at step (a) of the preferred embodiment;

FIG. 3 is a perspective view illustrating a ferromagnetic core unit used in the preferred embodiment;

FIG. 4 is a cross-sectional view illustrating step (b) of disposing ferromagnetic core units of FIG. 3 in the receiving spaces according to the preferred embodiment;

FIG. 5 is a top view illustrating another configuration of the receiving spaces in the substrate formed by step (a) of the preferred embodiment;

FIG. 6 is a perspective view illustrating the ferromagnetic core unit that has a shape corresponding to that of a respective one of the receiving spaces shown in FIG. 5;

FIGS. 7 and 8 are top views illustrating the ferromagnetic core units with different shapes and received in the receiving spaces with shapes respectively corresponding to those of the ferromagnetic core units;

FIG. 9 is a schematic view of the preferred embodiment at step (c), in which metal foils are disposed on two opposite surfaces of the substrate through adhesives;

FIG. 10 is a schematic view of the preferred embodiment at step (c), in which through holes are formed in the substrate after the step shown in FIG. 9;

FIG. 11 is a top view illustrating the distribution of the through holes in the substrate after the step shown in FIG. 10, in which the metal foil and the adhesive on one of the surfaces of the substrate are omitted for clarity;

FIG. 12 shows consecutive steps of forming conductive traces at step (c) of the preferred embodiment;

FIG. 13 is a schematic diagram illustrating the pattern of the conductive traces that are electrically connected to conductive vias; and

FIGS. 14, 15 and 16 are top views illustrating different configurations of the inductive modules made by the preferred embodiment.

### DETAILED DESCRIPTION OF THE PREFERRED EMBODIMENT

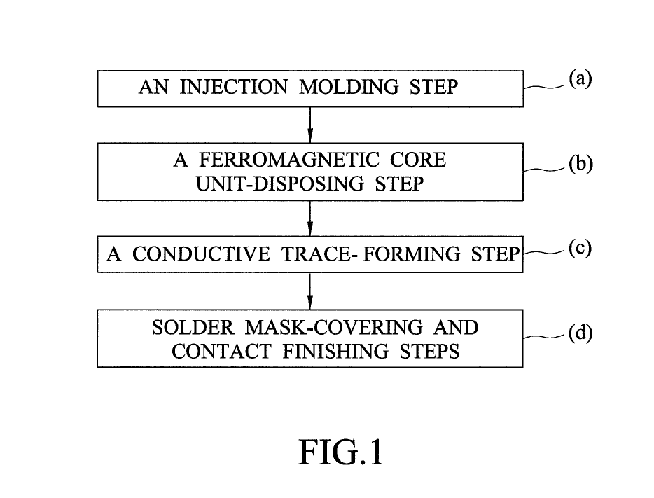

Referring to FIG. 1, the preferred embodiment of a method of manufacturing an inductive module according to this invention includes: (a) an injection molding step; (b) a ferromagnetic core unit-disposing step; (c) a conductive trace-forming step; and (d) solder mask-covering and contact finishing steps.

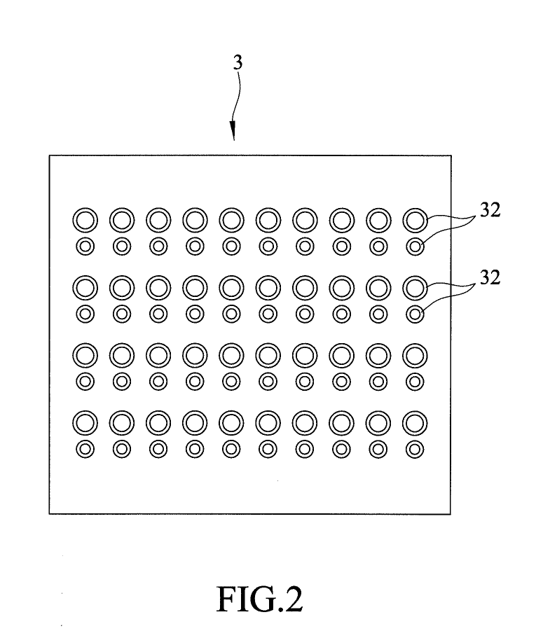

Referring to FIG. 2, in step (a), a plastic material is subjected to an injection molding process so as to form a substrate 3 that has opposite first and second surfaces and a plurality of receiving spaces 32 indented from the first surface to the second surface. The plurality of receiving spaces 32 are used to receive a plurality of ferromagnetic core units 4 (see FIG. 4), followed by dicing so as to improve processing convenience and reduce manufacturing costs. The plastic material is a thermoplastic material or a thermosetting plastic material. The thermoplastic material is selected from the group consisting of polyphenylene sulfide (PPS), liquid crystal polyester (LCP), polycarbonate hexandimethanol terephthalate (PCT) and combinations thereof. The thermosetting plastic material is selected from the group consisting of phenolic resins (bakelite), poly(diallyl phthalate) (DAP), and the combination thereof. It should be noted that the plastic material should be capable of withstanding temperature of at least 220° C.

It should be noted that a conventional printed circuit board is generally made from a FR-4 resin material which is a composite material of an epoxy resin and a glass fiber and which is not suited for use in an injection molding process.

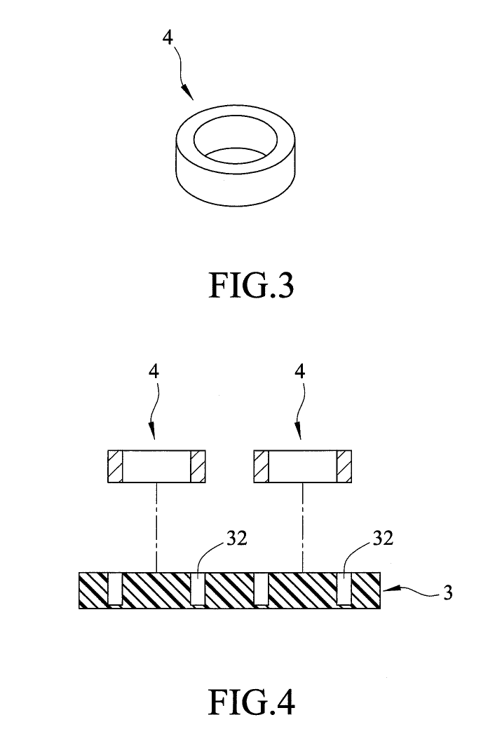

Referring to FIGS. 1, 3 and 4, in step (b), a ferromagnetic core unit 4 is disposed in a respective one of the receiving spaces 32. The number of the receiving spaces 32 can be adjusted according to the size of the ferromagnetic core unit 4. As shown in FIGS. 2 and 3, in this embodiment, each of the receiving spaces 32 is composed of a large ring-like subspace and a small ring-like subspace disposed adjacent to the large ring-like subspace, and the ferromagnetic core unit 4 includes a large ring-like ferromagnetic core and a small ring-like ferromagnetic core respectively disposed in the large and small ring-like subspaces.

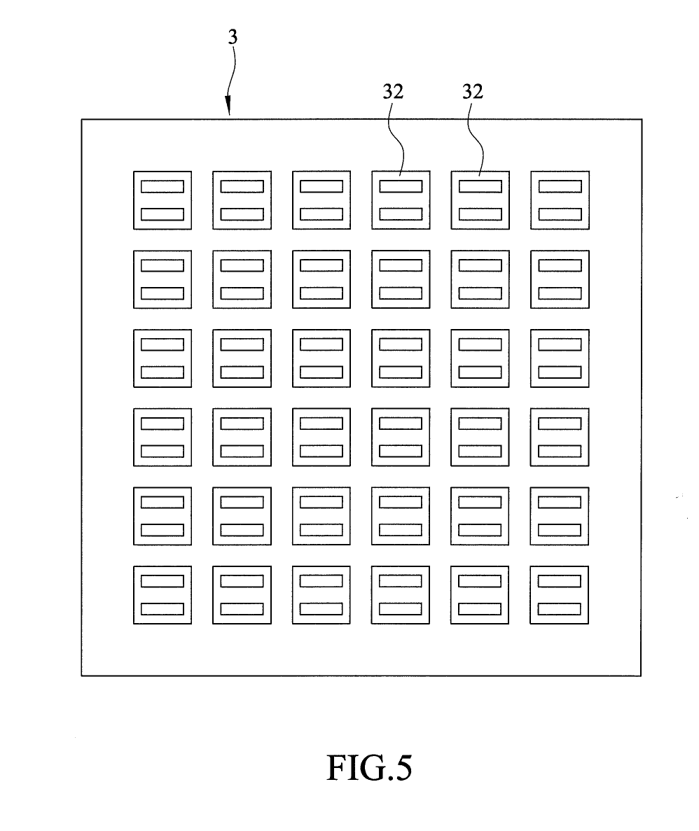

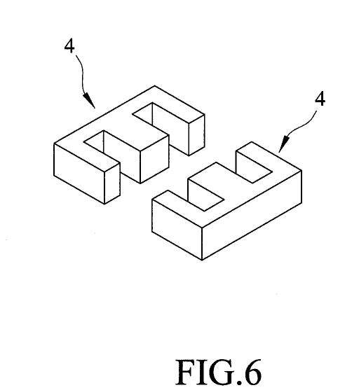

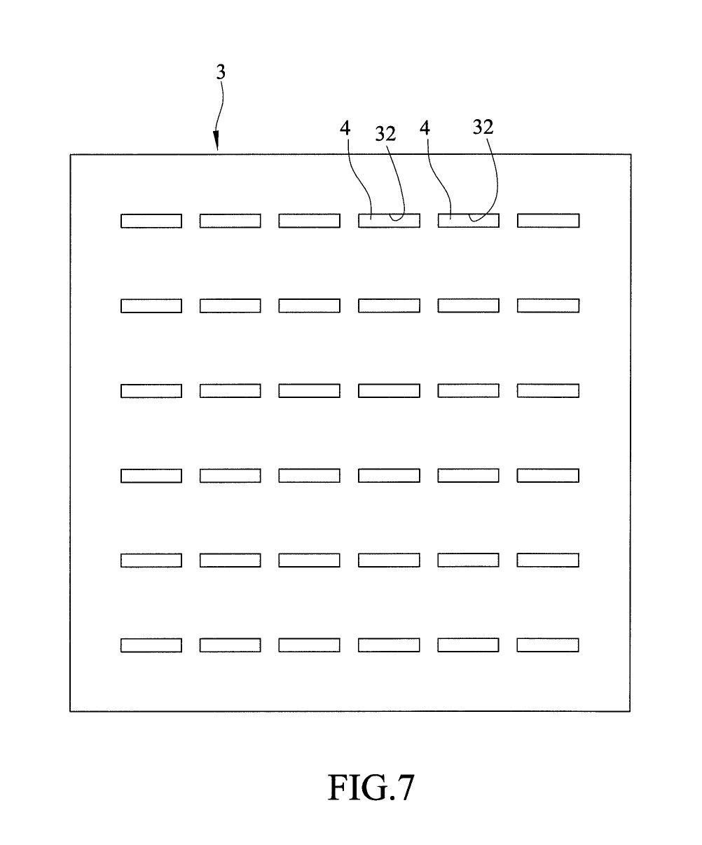

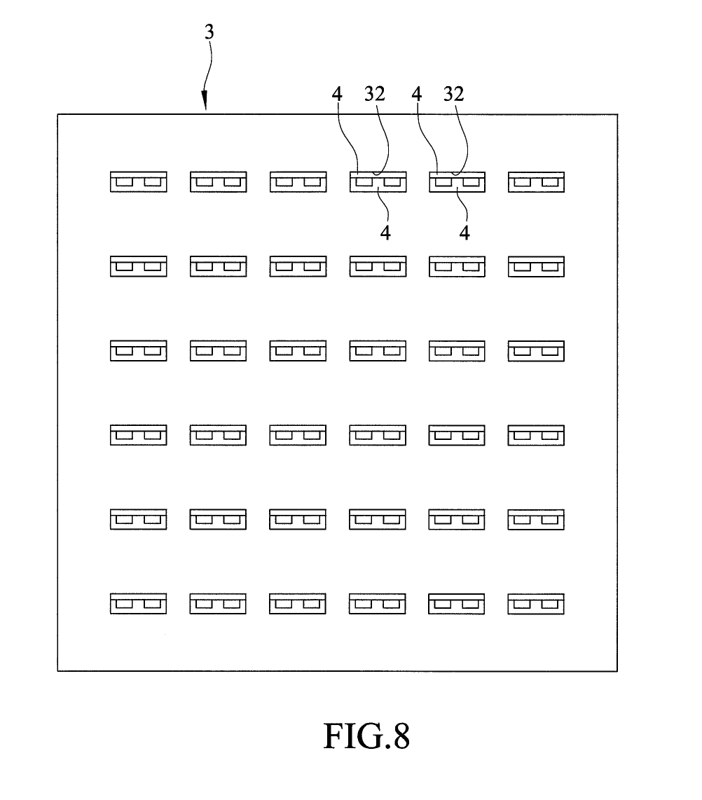

It should be noted that the configurations of the receiving space 32 and the ferromagnetic core unit 4 are not limited to the aforesaid example. The shape of the receiving space 32 can be changed in order to fit different shapes of the ferromagnetic core unit 4. For example, each of the receiving spaces 32 may have a shape shown in FIG. 5 which can receive the ferromagnetic core unit 4 composed of two E-shaped ferromagnetic cores (see FIG. 6). Referring to FIG. 7, each of the receiving spaces 32 may have a rectangular shape that can receive the ferromagnetic core unit 4 with a rectangular shape. Moreover, referring to FIG. 8, each of the receiving spaces 32 may have a shape that can receive the ferromagnetic core unit 4 composed of a rectangular ferromagnetic core and a W-shaped ferromagnetic core. The receiving spaces 32 and the ferromagnetic core unit 4 shown in FIGS. 3 and 4 are used as an example for further illustration. Alloys of manganese/zinc (MnZn) and nickel/zinc (NiZn), which are easily magnetized, are the most common material for the ferromagnetic core unit 4.

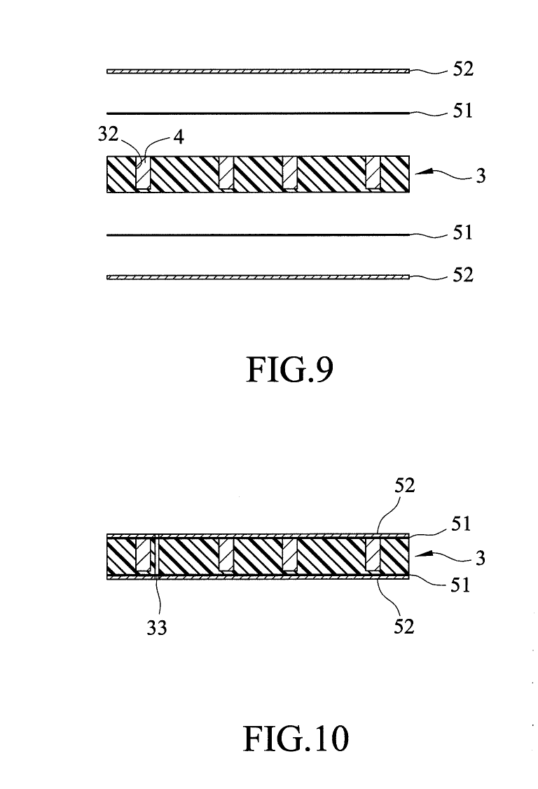

Referring to FIG. 9, preferably, the ferromagnetic core unit 4 is completely received in the respective one of the receiving spaces 32 in this embodiment. Alternatively, the ferromagnetic core unit 4 could be slightly protruded from the respective one of the receiving spaces 32.

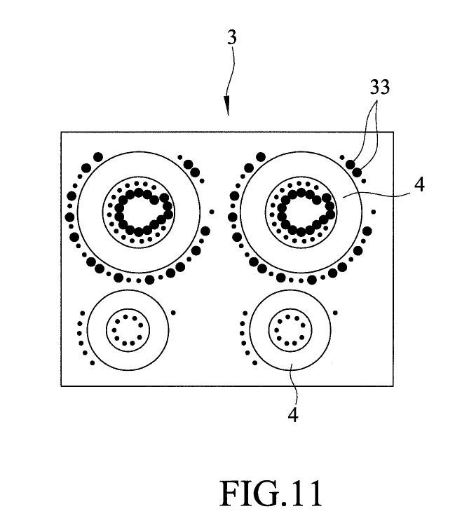

Referring to FIGS. 1 and 9, in step (c), an adhesive 51 and a metal foil 52 are sequentially laminated on each of the first and second surfaces of the substrate. Preferably, the metal foil 52 is a copper foil. The number of the metal foil 52 can be adjusted based on actual requirements. Then, referring to FIGS. 10 and 11, through holes 33 are formed by a drilling process in the substrate 3. In this embodiment, the through holes 33 are formed to have an arrangement and sizes as shown in FIG. 11, the through holes 33 are then subjected to a series of processes to form conductive vias. Specifically, the through holes 33 are subjected to debur pre-treatment by brushing and high-pressure water rinsing, and a desmear treatment using a potassium permanganate solution. Then, a hole-defining wall that defines a corresponding one of the through holes 33 is covered by a layer of palladium-tin colloid film, followed by formation of a palladium layer on the hole-defining wall through redox reaction between stannous ions and palladium ions and deposition of a copper layer on the hole-defining wall a by copper electroplating method using a copper sulfate solution. The conductive vias are thus formed.

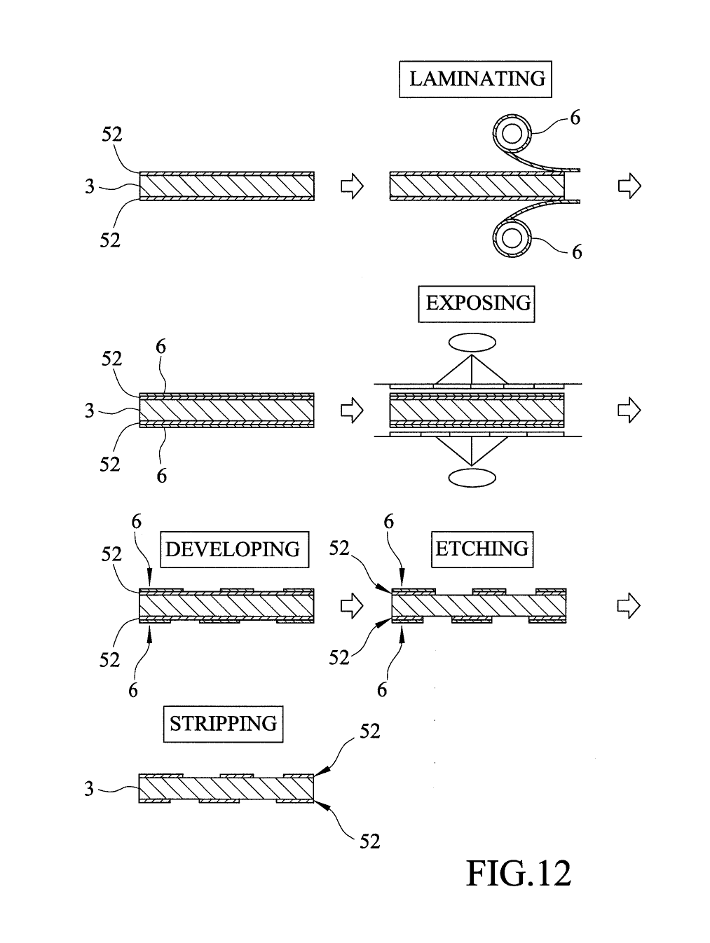

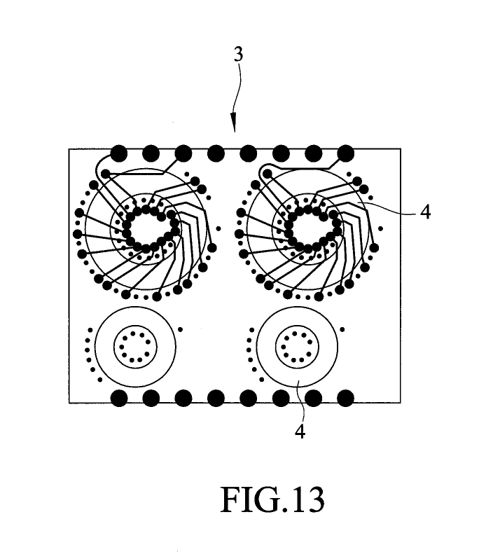

In step (c), the metal foil 52 on each of the first and second surfaces of the substrate 3 is processed to form conductive traces. Specifically, as shown in FIG. 12, a photoresist 6 is laminated on the metal foil 52 on each of the first and second surfaces of the substrate 3 and then exposed to ultra violet light. After the exposure process, the developing process is carried out to remove part of the photoresist 6. The metal foil 52 is then etched, followed by stripping to remove the rest of the photoresist 6 so that the conductive traces are formed on the substrate 3. Each of the conductive traces is electrically connected to a corresponding pair of the conductive vias (see FIG. 13) so as to form a winding wound around the ferromagnetic core unit 4. Step (c) can be repeated based on actual requirements.

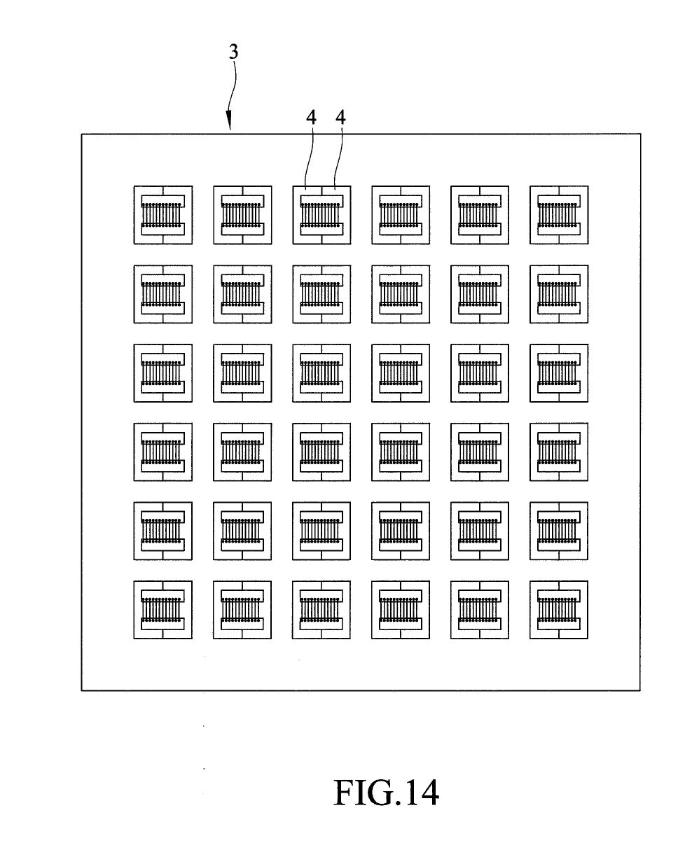

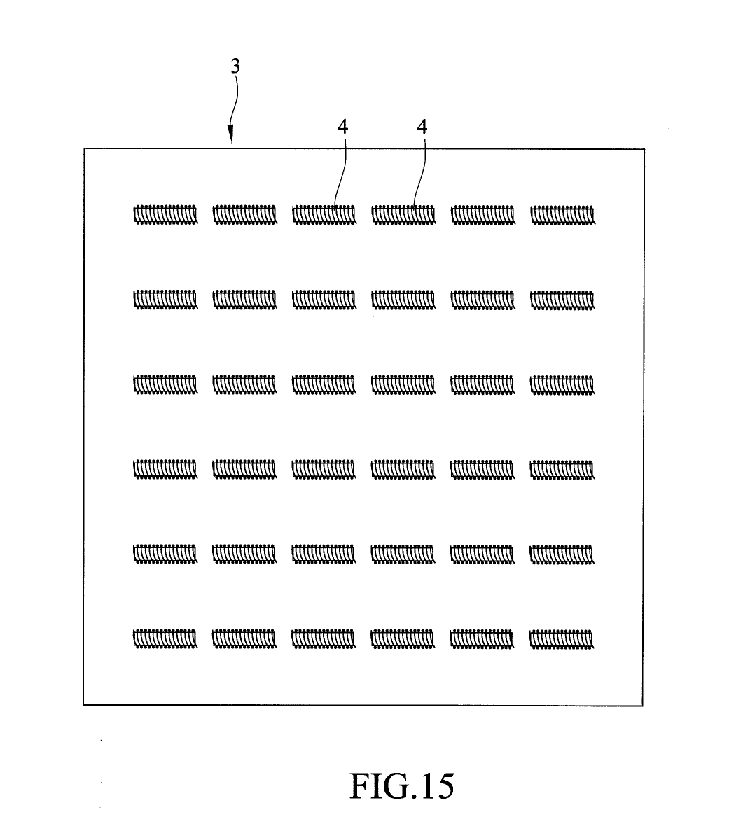

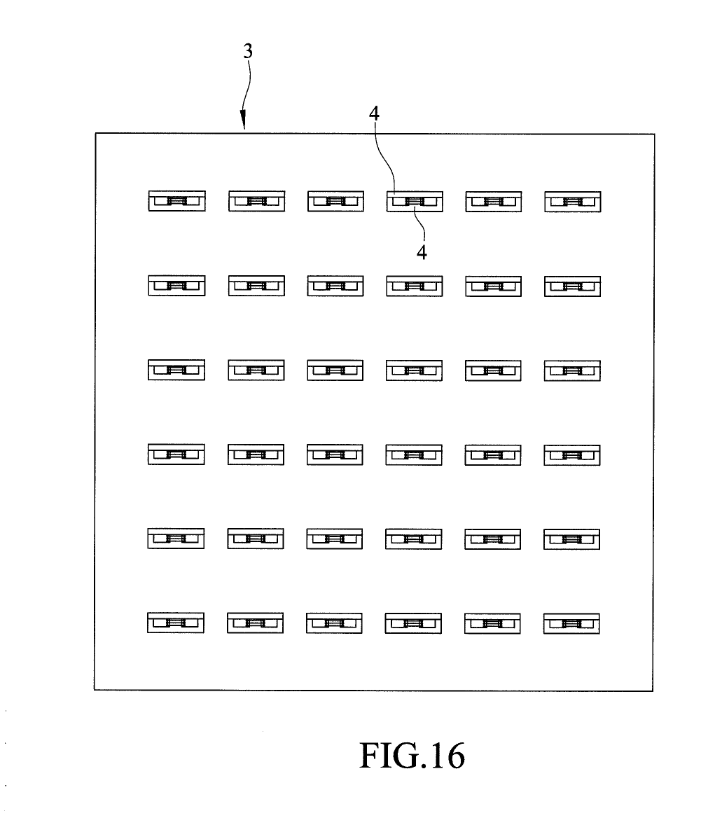

If the assemblies of the substrate 3 and the ferromagnetic core unit 4 shown in FIGS. 5, 7, and 8 are subjected to step (c), the windings thus formed would have the patterns as shown in FIGS. 14, 15, and 16. Finally, referring to FIG. 1, in step (d), the conductive traces thus formed are covered with a solder mask such that a part of the conductive traces are exposed to serve as contacts, followed by subjecting to a contact finishing process so as to form the inductive module. Since step (c) and step (d) are common procedures in manufacturing a printed circuit board and are well known to a skilled artisan, detailed descriptions thereof are omitted herein for the sake of brevity.

Preferably, the inductive module may be further printed with legends, trademark, or lot number using screen printing followed by a curing procedure. The substrate is then cut into a proper size. After checking electrical functions and outer appearance, the inductive module is ready for packaging and shipping.

A surface mount component (SMC) may be attached to the inductive module through a surface mount technology (SMT) using a lead-free solder, e.g., a tin paste or a tin wire. The plastic material selected from the thermoplastic material and the thermosetting material should be capable of withstanding temperature of at least 220° C. according to the present invention such that the substrate will not carbonize or deform due to the high temperature during the SMT process.

To sum up, by using an injection molding process to form the substrate with the receiving space instead of using the aforesaid conventional lamination procedure, the method of the present invention is effectively simplified, manufacturing costs could be reduced, and yield of the resultant product could be increased.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A method of manufacturing an inductive module, comprising:
(a) injection molding a plastic material to form a substrate that has opposite first and second surfaces and at least one receiving space indented from the first surface to the second surface;
(b) disposing a ferromagnetic core unit in the receiving space;
(c) forming conductive traces on the first and second surfaces of the substrate and forming conductive vias through the substrate, each of the conductive traces being electrically connected to a corresponding pair of the conductive vias; and
(d) covering the conductive traces with a solder mask such that a part of the conductive traces are exposed to serve as contacts, followed by subjecting to a contact finishing process.

2. The method as claimed in claim 1, wherein the plastic material is a thermoplastic material that is capable of withstanding temperature of at least 220° C.

3. The method as claimed in claim 2, wherein the thermoplastic material is selected from the group consisting of polyphenylene sulfide (PPS), liquid crystal polyester (LCP), polycarbonate hexandimethanol terephthalate (PCT) and combinations thereof.

4. The method as claimed in claim 1, wherein the plastic material is a thermosetting plastic material that is capable of withstanding temperature of at least 220° C.

5. The method as claimed in claim 4, wherein the thermosetting plastic material is selected from the group consisting of phenolic resins (bakelite), poly(diallyl phthalate) (DAP), and the combination thereof.

6. The method as claimed in claim 1, wherein the ferromagnetic core unit is completely received in the receiving space.
